(19) United States
(12) Patent Application Publication
(10) Pub. No.: US 2005/0219991 A1
(43) Pub. Date: Oct. 6, 2005

(54) Dual stack optical data storage medium

(75) Inventors: Ronald Joseph Antonius Van Den Oetelaar, Eindhoven (NL); Hubert Cecile Francois Martens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Groenewoudseweg 1 (NL)

(21) Appl. No.: 10/509,461

(22) PCT Filed: Apr. 1, 2003
(86) PCT No.: PCT/IB03/01290

§ 371 Date: Sep. 28, 2004

(30) Foreign Application Priority Data
Apr. 2, 2002 (EP) 02076287.8
Dec. 13, 2002 (EP) 02080276.5

(51) Int. Cl. G11B 7/24

(52) U.S. Cl. 369/275.1; 369/94

(57) ABSTRACT

A dual stack optical data storage medium (30) for recording and reading by means of a focused radiation beam (29) is described. The beam enters the medium (30) through a first radiation beam entrance face (21). The medium has at least a first substrate (1a) with on at least one side of the first substrate (1a) a first layer stack (2), comprising a first information layer (3), a second layer stack (5), comprising a second information layer (6) and a first transparent spacer layer (4) between the first layer stack (2) and the second layer stack The first layer stack (2) is present at a position closer to the first radiation beam entrance face (21) than the second layer stack (5). The first information layer (3) is one selected from the group of types consisting of a read only layer and a write once layer, and 10 the second information layer (6) is one selected from the group of types consisting of a read only layer, a write once layer and a rewritable layer. The type of the first information layer (3) is different from the type of the second information layer (6). Compatibility of the medium with read only standards is achieved while the advantages of writability and erasability are maintained. Double sided versions of the medium are also described having a 15 third and fourth layer stack (7, 10).

The invention relates to a dual stack optical data storage medium for recording and reading by means of a focused radiation beam entering the medium through a first radiation beam entrance face, said medium having at least a first substrate with on at least one side of the first substrate:
a first layer stack, comprising a first information layer,
a second layer stack, comprising a second information layer, said first layer stack being present at a position closer to the first radiation beam entrance face than the second layer stack,
a first transparent spacer layer between the first layer stack and the second layer stack

An embodiment of an optical recording medium as described in the opening paragraph is known from Japanese Patent Application JP-11066622.

Digital Versatile Disc read only (DVD-ROM) has proven to be a very successful optical storage medium. The DVD-ROM standard specification describes both a single-stack disk (type A; data capacity=4.7 GB) as well as a dual-stack disk (type C; data capacity=8.5 GB). A write once and/or rewritable medium which is compatible with the type A and type C DVD-ROM standard is highly desirable. Furthermore, a double-sided version of the single-stack disk (type B; data capacity=9.4 GB) and a double-sided version of the dual-stack disk (type D; data capacity=17.0 GB) are described. Recordable and/or rewritable media which are compatible with the DVD-ROM standard are highly desirable. Recently a new format has been introduced called Blu-ray Disc (BD) with even a higher storage capacity. This system uses a blue radiation beam wavelength and a relatively high numerical aperture of the focused radiation beam. For this format also write once (R) and rewritable (RW) versions will be introduced.

For the single-stack DVD (type A) a compatible recordable format (DVD+R) and a nearly compatible rewritable format (DVD+RW) have been defined. For the dual-stack DVD (type C), a compatible dual-stack recordable DVD(+R) medium based on dye materials is described in non-prepublished European Patent Application no. 02075226.7 (PHNL020086) filed by the present applicant. A dual-stack rewritable DVD(+RW) medium is also feasible, but it seems that such a medium cannot be made compatible with the DVD-ROM standard, because of the limited reflection and transmission of the rewritable materials, e.g. phase-change materials, that are used.

The increase in data capacity of a dual-stack DVD+R compared to a single-layer DVD+R and its compatibility with read only standards are clear advantages. However a disadvantage is that it is rather cumbersome to provide such a disc with prerecorded data. Furthermore, data which has become obsolete cannot be overwritten.

It is an object of the invention to provide a dual stack optical data storage medium of the type mentioned in the opening paragraph which is compatible with a dual stack ROM version of said medium and has a rewritable portion or read only portion.

This object is achieved by a dual stack optical data storage medium according to the invention which is characterized in that the first information layer is one selected from the group of types consisting of a read only layer and a write once layer, and that the second information layer is one selected from the group of types consisting of a read only layer, a write once layer and a rewritable layer, and that the type of the first information layer is different from the type of the second information layer.

Applicant has recognized that the problem with a dual-stack recordable, i.e. write once, medium is that prerecorded read only data, which a manufacturer would desire to put on such a medium, have to be written sequentially medium by medium. This problem is solved by providing a medium wherein one of the first and second information layers is a read only layer with preembossed information as, e.g., in a normal DVD-ROM. A further problem is that an end user who desires to add his own information will not be able to erase this information anymore. Applicants have further recognized that with a combination of different types of recording layers according to the invention it still is possible to achieve a dual stack medium compatible with the dual layer (=stack) DVD ROM standard. It is important to recognize that the first information layer cannot be a rewritable layer because than the requirements on effective reflection, i.e. compatible with a dual stack ROM version, of both stacks cannot be met anymore. A suitable rewritable layer has too little optical transmission, i.e. too much absorption, in order to achieve this compatibility. E.g. an important parameter of the type C DVD-ROM standard is the reflectivity of the storage layers, which must be between 18% and 30% for each of the two layers. Consequently, the first information layer closest to the radiation beam entrance face of a compatible DVD+R+RW medium should have a high transmission, sufficient reflection and low absorption. These criteria can be met for a write once layer based on e.g. dye materials or a read only layer, but cannot be met for a rewritable layer, which has a relatively high optical absorption. In other words, the first information layer is a write once (e.g. a dye based layer with a relatively low absorption) layer or read only ROM layer (low absorption), while the second information layer is a relatively highly reflective rewritable layer, e.g. based on phase-change materials or other erasable materials like magneto-optical materials. It should be noted that for the write once layer any type of layer with a relatively low absorption at the radiation beam wavelength is suitable and that the write once layer of the invention is not restricted to dye layers.

In an embodiment the second information layer is a rewritable layer. The advantage of such a medium is that half of the disk capacity can be rewritten. A very promising application is e.g. the use of a write once (R)+rewritable (RW) dual-stack DVD medium for storage of e.g. high-quality home videos. The raw video material, e.g. from a portable camcorder, can be stored on the write once layer, and if required by data capacity also partly on the rewritable layer, while the editing and/or scene selection information can be stored and rewritten, i.e. can be easily modified, on the rewritable layer. Or alternatively, a prerecorded example movie with video editing software may be provided on a read only layer and the end user puts his own raw material on the rewritable layer and edits it with the software, after practising with some examples, and subsequently records the edited version on the rewritable layer. The raw material may be erased in order to save space. The proposed example is compatible with the type C DVD-ROM standard, which implies that it can be played back on any DVD-player and DVD-recorder.

In another embodiment the first radiation beam entrance face is in a first protective cover layer separate from the first substrate. Recently, there is a tendency to use objective lenses which have a relatively high numerical aperture (NA) for focusing the radiation beam. This enables a smaller optical spot which allows a higher data density. For this system it is preferred to focus the radiation beam through a relatively thin transparent cover layer of the order of some tens of millimeters or less, e.g. 100 μm. The advantage is that such a relatively thin cover layer makes the focused optical spot less susceptible to optical aberrations by tilt of the optical medium and further that the objective may have a relatively small focus distance with still enough free working distance (FWD) for the objective to operate.

In yet another embodiment the medium further comprises a second radiation beam entrance face opposite from the first radiation beam entrance face and a third layer stack, comprising a third information layer selected from the group consisting of a read only layer and a write once layer, a fourth layer stack, comprising a fourth information layer selected from the group consisting of a read only layer, a write once layer and a rewritable layer, said third layer stack being present at a position closer to the second radiation beam entrance face than the fourth layer stack, a second transparent spacer layer between the third layer stack and the fourth layer stack, and that the type of the third information layer is different from the type of the fourth information layer.

The maximum data capacity of a single-sided dual-stack optical data storage medium is limited, e.g. to 8.5 GB for DVD. In order to store two versions of a movie in DVD format, including extra features, on one disc, e.g. a full-screen and wide-screen version as is commonly done for movies distributed in the U.S., 8.5 GB of storage capacity is generally insufficient. Therefore a compatible double-sided dual-stack optical recording medium medium is proposed. The proposed medium is compatible with its read only version, e.g. the type D DVD-ROM standard and consequently has a doubled total storage capacity, e.g. 17.0 GB in case of the type DVD-ROM. The double-sided dual-stack optical data storage medium may consist of two write once information layers and two rewritable information layers, e.g. DVD+R+RW. The two rewritable layers are located in between the write once layers, for reason of differences in optical properties between rewritable, e.g. phase-change, and write once, e.g. dye materials, as described above. One of the write once layers and one of the rewritable layers can be accessed from one side of the disc, while the other two layers can be accessed from the other side of the disc.

In case of the dual sided dual stack DVD-ROM compatible embodiments the first and second radiation beam entrance faces are in the first and a second substrate respectively.

In a special embodiment the second radiation beam entrance face is in the first substrate and the first radiation beam entrance face is in a first protective cover layer separate from the first substrate. This embodiment combines a relatively low density dual stack format on one side of the medium with a high density dual stack format on the other side. E.g. a combined DVD/BD.

In another embodiment the second radiation beam entrance face is in a second protective coverlayer and the first radiation beam entrance face is in a first protective cover layer separate from the first substrate. In this case protective cover layers are present on both sides of the dual sided dual stack optical data storage medium. At least the first substrate is present between the second and the fourth layer stack. A second substrate may be present adjacent the first substrate. The latter may occur when the the two sides of the medium are produced separately and connected together at a later stage in the production process by bonding the first substrate to the second substrate.

For an optical data storage medium compatible with the dual stack DVD-ROM specification the effective reflection level of the stacks is at least 0.18 at a radiation beam wavelength of approximately 655 nm.

For an optical data storage medium compatible with the dual stack BD specification the effective reflection level of the stacks ranges from 0.04 to 0.08 for dual-layer BD-RW and 0.12 to 0.24 for single-layer BD-RW, at a radiation beam wavelength of approximately 405 nm.

For a double sided optical data storage medium compatible with the dual stack DVD-ROM on one side and the dual stack BD specification on the other side the effective optical reflection level of the first and second stack is at least 0.18 at a radiation beam wavelength of approximately 655 nm and the effective optical reflection level of the third and fourth stack is at least 0.04 at a radiation beam wavelength of approximately 405 nm.

The invention will be elucidated in greater detail with reference to the accompanying drawings, in which

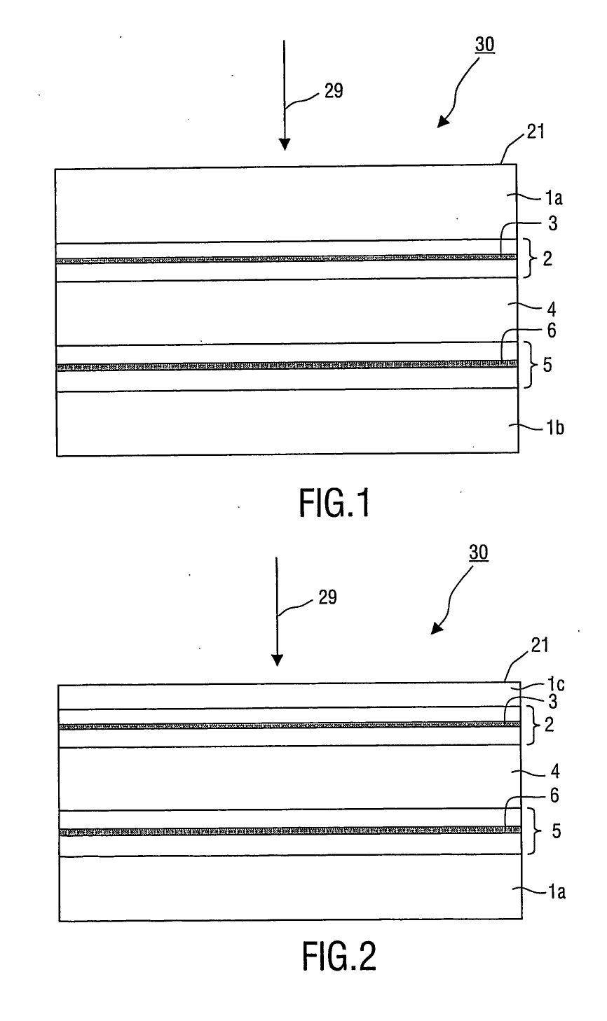

FIG. 1 shows a schematic layout of an embodiment of a dual-stack optical data storage medium according to the invention,

FIG. 2 shows a schematic layout of another embodiment of a dual-stack optical data storage medium according to the invention,

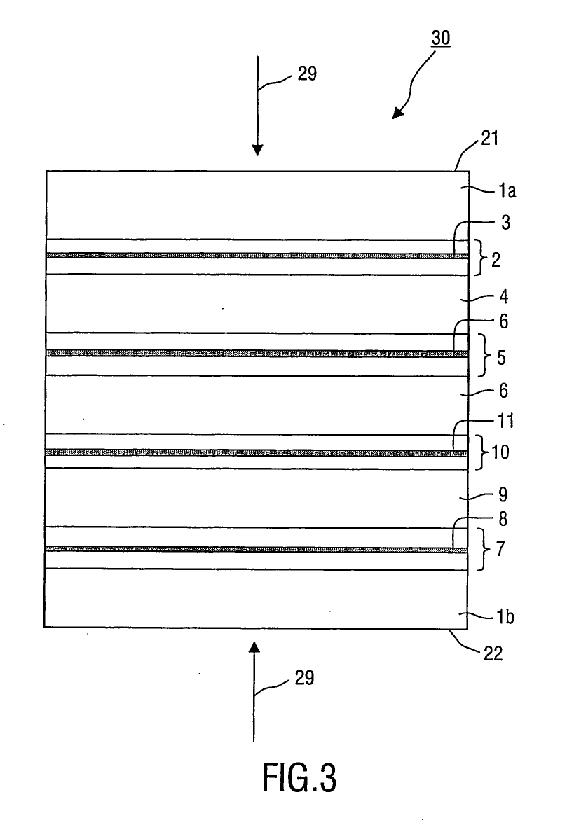

FIG. 3 shows a schematic layout of an embodiment of a double sided dual-stack optical data storage medium according to the invention,

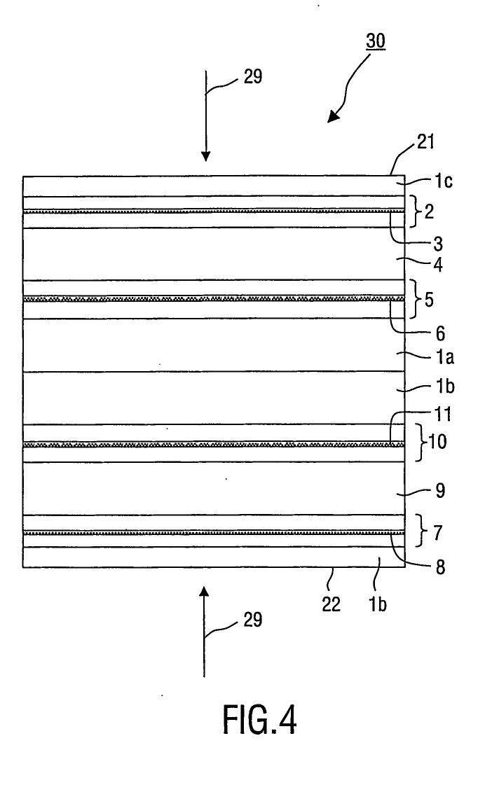

FIG. 4 shows a schematic layout of another embodiment of a double sided dual-stack optical data storage medium according to the invention.

In FIG. 1 a dual stack optical data storage medium 30 for recording and reading by means of a focused radiation beam 29 is shown. The radiation beam 29 enters the medium 30 through a first radiation beam entrance face 21. The medium has at least a first substrate 1a with on at least one side of the first substrate 1a a first layer stack 2, comprising a first information layer 3, a second layer stack 5, comprising a second information layer 6. The first layer stack 2 is present at a position closer to the first radiation beam entrance face than the second layer stack 5. A first transparent spacer layer 4 is present between the first layer stack 2 and the second layer stack 5. The first information layer 3 is a write once layer, and the second information layer 6 is a rewritable layer. The embodiment will now be discussed in more detail.

Substrate 1a has a servo pregroove or guide groove pattern in its surface at the side of the first layer stack 2 and is made of polycarbonate (n=1.58) and has a thickness of 580 μm. The servo pregroove is used for guiding the focused radiation beam 29 during recording and/or read out. First layer stack 2 is a write once stack comprising a first information layer 3 made of a cyanine dye or azo dye (n=2.2; k=0.01) having a thickness of 90 nm. The dye may be deposited by spincoating or evaporation. A semi transparent reflective layer of Au (n=0.28; k=3.9) having a thickness of 8 nm is present between the first information layer 3 and the spacer layer 4 and deposited by e.g. sputtering. The first transparent spacer layer 4 is made of an UV-curable resin or a pressure-sensitive adhesive (PSA) (n=1.5) with a thickness of 40-60 μm. The second layer stack 5 comprises, in this order, a first dielectric layer made of ZnS/SiO2 (80:20) (n=2.15) having a thickness of 135 μm and deposited by sputtering, a rewritable recording layer made of a phase-change GeInSbTe alloy (crystalline: n=2.9; k=4.8) having a thickness of 12 nm and deposited by sputtering, a second dielectric layer made of ZnS/SiO2 (80:20) (n=2.15) having a thickness of 23 nm and deposited by sputtering, a reflective layer made of Al (n=1.97; k=7.83) having a thickness of 100 nm and deposited by sputtering. A second substrate 1b, made of polycarbonate (n=1.58) and having a thickness of 580 μm, is present adjacent the second layer stack 5. The substrate 1b has a servo pregroove or guide groove pattern in its surface at the side of the second layer stack 5.

The listed optical parameters n and k are for λ=655 nm which is the radiation beam wavelength. The calculated reflection and transmission are:

First Layer Stack 2:

Reflection (R1)=20.2%
Transmission (T1)=64.1%
Effective reflection from first layer stack 2: =R1=20.2%
   Second Layer Stack 5:
Reflection (R2)=49.1%
Effective reflection from second layer stack 5: =T1×T1×R1=20.2%
   The effective reflection of both layers is in full compliance with the DVD-ROM standard: 18%<R<30%.

In FIG. 2 a dual stack optical data storage medium 30 for recording and reading by means of a focused radiation beam 29 is shown. The radiation beam 29 enters the medium 30 through a first radiation beam entrance face 21. The medium has a transparent cover layer 1c. On a first substrate 1a is present a first layer stack 2, comprising a first information layer 3, a second layer stack 5, comprising a second information layer 6. The first layer stack 2 is present at a position closer to the first radiation beam entrance face 21 than the second layer stack 5. A first transparent spacer layer 4 is present between the first layer stack 2 and the second layer stack 5. The first information layer 3 is a write once layer, and the second information layer 5 is a rewritable layer. The embodiment will now be discussed in more detail.

Cover layer 1c is made of an UV curable resin and has a thickness of 100 μm and may be applied by spincoating and subsequent UV curing. First layer stack 2 is a write once stack comprising a first information layer 3 made of an organic pigment (n=2.4; k=0.02) having a thickness of 50 nm. The pigment may be deposited by spincoating or evaporation. Transparent dielectric layers of e.g. SiO₂ (n=1.5; k=0.0), not drawn, both having a thickness of 20 nm, are present between the first information layer 3 and the spacer layer 4 and between the first information layer 3 and the cover layer 1c. These layers are deposited by e.g. sputtering. The spacer layer 4 is made of an UV curable resin and has a thickness of 20 μm. A servo pregroove pattern is present in the first transparent spacer layer 4 at the side of the transparent SiO₂ layer. The second layer stack 5 comprises, in this order, a first dielectric layer made of ZnS/SiO₂ (80:20) (n=2.2) having a thickness of 50 nm and deposited by sputtering, a rewritable recording layer made of a phase-change GeInSbTe alloy (crystalline: n=1.5; k=3.5) having a thickness of 13 nm and deposited by sputtering, a second dielectric layer made of ZnS/SiO2 (80:20) (n=2.2) having a thickness of 17 nm and deposited by sputtering, a reflective layer made of Ag (n=0.08; k=2.1) having a thickness of 120 nm and deposited by sputtering. The first substrate 1a is made of polycarbonate (n=1.58) and has a thickness of 1100 μm and is provided with a servo pregroove or guide groove pattern at the side of the second layer stack 5.

The listed optical parameters n and k are for λ=405 nm which is the radiation beam wavelength. The reflection and transmission are:

First Layer Stack 2:

Reflection (R1)=15%
Transmission (T1)=65%
Effective reflection from first layer stack 2: =R1=15%
   Second Layer Stack 5:
Reflection (R2)=29%
Effective reflection from second layer stack 5: =T1×T1×R1=12%
   The effective reflection of both layers is in full compliance with the single-layer BD-RW standard: 12%<R<24%.

In FIG. 3 a double sided dual stack optical data storage medium 30 is shown compatible with the type D DVD-ROM standard. Reference numerals 1a, 21, 2, 3, 5, 6 correspond to the description of FIG. 1. The first transparent spacer layer 4 is made of an UV-curable resin and has a servo pregroove or guide groove pattern in its surface at the side of the second layer stack 5. Substrate 1b of FIG. 1 is replaced by a coupling layer 12. The medium further comprises a second radiation beam entrance face 22 opposite from the first radiation beam entrance face 21 for recording and reading in a third layer stack 7, comprising a third information layer 8, and a fourth layer stack 10, comprising a fourth information layer 11. The third layer stack 7 is present at a position closer to the second radiation beam entrance face 22 than the fourth layer stack 10. A second transparent spacer layer 9 is present between the third layer stack 7 and the fourth layer stack 10. The layers and stacks 1b, 7, 8, 9, 10 and 11 are identical to respectively the layers and stacks 1a, 2, 3, 4, 5, 6. Hence a dual sided dual stack medium is provided with identical design on both sides bonded together by coupling layer 12 which may be a PSA with a thickness of 20-300 μm. Depending on the thickness of the substrates 1a and 1b and the spacer layers 4 and 9, the thickness of the coupling layer 12 may be adjusted in order to have the total thickness of the medium 30 not exceed the maximum thickness as specified in the DVD disk standard, i.e. 1500 μm. The thickness range of the substrate however is also limited in order to prevent occurrence of excessive optical aberrations in the focused radiation beam 29 used for reading and writing in the information layers.

The pregroove (or guide groove) of the second layer stack 5 and the fourth layer stack 10 may also be present in the coupling layer 12 in which case the coupling layer may constitute a sheet of plastic with pregrooves on both sides. In this case, spacer layers 4 and 9 may constitute an UV-curable resin or pressure-sensitive adhesive (PSA) without pregroove.

The calculated reflection and transmission for λ=655 nm are:

First Layer Stack 2 and Third Layer Stack 7:

Reflection (R1)=20.2%
Transmission (T1)=64.1%
Effective reflection from first or third layer stack 2 or 7: =R1=20.2%
   Second Layer Stack 5 and Fourth Layer Stack 10:
Reflection (R2)=49.1%
Effective reflection from second or fourth layer stack 5 or 10: =T1×T1×R1=20.2%
   The effective reflection of both layers is in full compliance with the DVD-ROM standard: 18%<R<30%.

In FIG. 4 a double sided dual stack optical data storage medium 30 for recording and reading by means of a focused radiation beam 29 is shown. The radiation beam 29 enters the medium 30 through a first radiation beam entrance face 21. The medium has a transparent cover layer 1c. On a first substrate 1a is present a first layer stack 2, comprising a first information layer 3, a second layer stack 5, comprising a second information layer 6. The first layer stack 2 is present at a position closer to the first radiation beam entrance face 21 than the second layer stack 5. A first transparent spacer layer 4 is present between the first layer stack 2 and the second layer stack 5. The first information layer 3 is a write once layer, and the second information layer 5 is a rewritable layer. The embodiment will now be discussed in more detail.

Cover layer 1c is made of an UV curable resin and has a thickness of 100 μm and may be applied by spincoating and subsequent UV curing. First layer stack 2 is a write once stack comprising a first information layer 3 made of an organic pigment (n=2.4; k=0.02) having a thickness of 50 nm. The pigment may be deposited by spincoating or evaporation. Transparent dielectric layers of e.g. SiO₂ (n=1.5; k=0.0), not drawn, both having a thickness of 20 nm, are present between the first information layer 3 and the spacer layer 4 and between the first information layer 3 and the cover layer 1c. These layers are deposited by e.g. sputtering. The spacer layer 4 is made of an UV curable resin and has a thickness of 20 μm. A servo pregroove pattern is present in the first transparent spacer layer 4 at the side of the transparent SiO₂ layer. The second layer stack 5 comprises, in this order, a first dielectric layer made of ZnS/SiO2 (80:20) (n=2.2) having a thickness of 50 nm and deposited by sputtering, a rewritable recording layer made of a phase-change GeInSbTe alloy (crystalline: n=1.5; k=3.5) having a thickness of 13 nm and deposited by sputtering, a second dielectric layer made of ZnS/SiO2 (80:20) (n=2.2) having a thickness of 17 nm and deposited by sputtering, a reflective layer made of Ag (n=0.08; k=2.1) having a thickness of 120 nm and deposited by sputtering. The first substrate 1a is made of polycarbonate (n=1.58) and has a thickness of about 0.50 mm and is provided with a servo pregroove or guide groove pattern at the side of the second layer stack 5. The medium 30 further comprises a second radiation beam entrance face 22 opposite from the first radiation beam entrance face 21 and a third layer stack 7, comprising a third information layer 8 selected from the group consisting of a read only layer and a write once layer, and a fourth layer stack 10, comprising a fourth information layer 11 selected from the group consisting of a read only layer, a write once layer and a rewritable layer, said third layer stack 7 being present at a position closer to the second radiation beam entrance face 22 than the fourth layer stack 10, and a second transparent spacer layer 9 between the third layer stack 7 and the fourth layer stack 10. The type of the third information layer 8 is different from the type of the fourth information layer 11. A second substrate 1b is present. The second radiation beam entrance face 22 is in a second protective coverlayer 1d. The respective reference numerals 1d, 7, 8, 9, 10, 11 and 1b correspond, mutatis mutandis, to the description of reference numerals 1c, 2, 3, 4, 5, 6 and 1a as described above. Substrate 1a and 1b are bonded together by known means. Substrate 1a and 1b may be combined as to form one single substrate in which case this substrate has a thickness of about 1.00 mm and has a pregroove in both sides of the single substrate.

The listed optical parameters n and k are for λ=405 nm which is the radiation beam wavelength. The reflection and transmission are:

First Layer Stack 2 and Third Layers Stack 7:

Reflection (R1)=15%
Transmission (T1)=65%
Effective reflection from first layer stack 2 or 7: =R1=15%
   Second Layer Stack 5 and Fourth Layer Stack 10:
Reflection (R2)=29%
Effective reflection from second layer stack 5 or 10: =T1×T1×R1=12%
   The effective reflection of all stacks is in full compliance with the single-layer BD-RW standard: 12%<R<24%.

It should be noted that the above-mentioned embodiment illustrates rather than limits the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

A dual stack optical data storage medium for recording and reading by means of a focused radiation beam is described. The beam enters the medium through a first radiation beam entrance face. The medium has at least a first substrate with on at least one side of the first substrate a first layer stack, comprising a first information layer, a second layer stack, comprising a second information layer and a first transparent spacer layer between the first layer stack and the second layer stack. The first layer stack is present at a position closer to the first radiation beam entrance face than the second layer stack. The first information layer is one selected from the group of types consisting of a read only layer and a write once layer, and the second information layer is one selected from the group of types consisting of a read only layer, a write once layer and a rewritable layer. The type of the first information layer is different from the type of the second information layer. Compatibility of the medium with read only standards is achieved while the advantages of writability and erasability are maintained. Double sided versions of the medium are also described having a third and fourth layer stack.

1. A dual stack optical data storage medium for recording and reading by means of a focused radiation beam entering the medium through a first radiation beam entrance face, said medium having at least a first substrate with on at least one side of the first substrate:
a first layer stack, comprising a first information layer,
a second layer stack, comprising a second information layer, said first layer stack being present at a position closer to the first radiation beam entrance face than the second layer stack,
a first transparent spacer layer between the first layer stack and the second layer stack, characterized in that the first information layer is one selected from the group of types consisting of a read only layer and a write once layer, and that the second information layer is one selected from the group of types consisting of a read only layer, a write once layer and a rewritable layer, and that the type of the first information layer is different from the type of the second information layer.

2. A dual stack optical data storage medium as claimed in claim 1, wherein the second information layer is a rewritable layer.

3. A dual stack optical data storage medium as claimed in claim 1, wherein the first radiation beam entrance face is in a first protective cover layer separate from the first substrate.

4. A dual stack optical data storage medium as claimed in claim 1, wherein the medium further comprises a second radiation beam entrance face opposite from the first radiation beam entrance face and
a third layer stack, comprising a third information layer selected from the group consisting of a read only layer and a write once layer,
a fourth layer stack, comprising a fourth information layer selected from the group consisting of a read only layer, a write once layer and a rewritable layer, said third layer stack being present at a position closer to the second radiation beam entrance face than the fourth layer stack,
a second transparent spacer layer between the third layer stack and the fourth layer stack, and that the type of the third information layer is different from the type of the fourth information layer.

5. A dual stack optical data storage medium as claimed in claim 3, wherein the second radiation beam entrance face is in the first substrate.

6. A dual stack optical data storage medium as claimed in claim 3, wherein the second radiation beam entrance face is in a second protective cover layer.

7. A dual stack optical data storage medium as claimed in claim 4 wherein the fourth information layer is a rewritable layer.

8. A dual stack optical data storage medium as claimed in claim 1, wherein the effective reflection level of the stacks is at least 0.18 at a radiation beam wavelength of approximately 655 nm.

9. A dual stack optical data storage medium as claimed in claim 3, wherein the effective reflection level of the stacks is at least 0.04 at a radiation beam wavelength of approximately 405 nm.

10. A dual stack optical data storage medium as claimed in claim 5, wherein the effective reflection level of the first and second stack is at least 0.04 at a radiation beam wavelength of approximately 405 nm and the effective reflection level of the third and fourth stack is at least 0.18 at a radiation beam wavelength of approximately 655 nm.
